(19) United States
(12) Patent Application Publication
(10) Pub. No.: US 2017/0173859 A1
(43) Pub. Date: Jun. 22, 2017

(54) APPARATUS FOR THE MANUFACTURE OF A PANEL OF INDIVIDUAL CELLULAR COMPARTMENTS FROM AN ELONGATE SHEET OF FLEXIBLE MATERIAL

(71) Applicant: RHINOKORE COMPOSITES SOLUTIONS LP, Calgary (CA)

(72) Inventor: LAWRENCE ALEXANDER HRUSCHAK, FORT SASKATCHEWAN (CA)

(21) Appl. No.: 15/367,465

(22) Filed: Dec. 2, 2016

Related U.S. Application Data
(60) Provisional application No. 62/270,091, filed on Dec. 21, 2015.

(51) Int. Cl. B29C 65/48; B29C 65/00; B29C 65/02

(52) U.S. Cl. CPC B29C 65/48; B29C 65/02; B29C 66/01; B29L 2009/00

(57) ABSTRACT

An apparatus for the manufacture of a panel of individual cellular compartments from an elongate sheet of flexible material. The apparatus comprises first and second rod banks and a feed head reciprocally moveable longitudinally and generally parallel along the rod banks. The feed head applies the flexible material about the exterior side surfaces of the rods of one of the rod banks when moving in one direction, and applies the flexible material about the exterior surfaces of the rods of the other of the rod banks when moving in the opposite direction, to thereby apply sequential layers of the flexible material to the exterior surface of the rods of the rod banks in an alternating fashion. The sequential layers of flexible material are secured to one another at points of contact along the length of the rods to form successive rows of conjoined compartments that form a panel.

### FIELD

This invention relates to an apparatus used in the manufacture of a panel of individual cellular compartments from an elongate sheet of flexible material, wherein the individual cellular compartments may then be filled with form and/or resin and/or other material to form a rigid or semi-rigid panel.

### BACKGROUND

Panels formed from parallel, tubular, honeycomb or other geometrically shaped cells have been made and proposed for use in a wide variety of applications. Such panels may be formed through the manufacturing of a core formed from a series of parallel, adjacent cells, wherein the core is to be later filled with form and/or resin and/or other material to add rigidity, compressive strength, thermal insulating capacity, etc. If desired, the upper and lower surface of the core may be covered with protective coatings, sheets, or resinous materials. The cellular compartments themselves may be formed from a wide variety of materials, including paper, aluminum, various types of plastic materials, fibreglass or other synthetic matting or woven materials. A panel of individual cellular compartments, and a composite material formed from such a panel, is described in Canadian Patent 2,639,673.

While others have proposed a variety of different mechanisms and methods for manufacturing such panels, it will be appreciated that in many instances the methods of manufacturing can be complex or laborious, and the throughput of a manufacturing process relatively low.

### SUMMARY

Accordingly, in one of its aspects the invention provides An apparatus for the manufacture of a panel of individual cellular compartments from an elongate sheet of flexible material, the apparatus comprising first and second rod banks, each of said rod banks including a base and a plurality of elongate and parallel rods, said bases oriented in a spaced apart and generally parallel configuration, said rods arranged adjacently in a row along each respective base and generally equally spaced apart from one another on said respective base, said rods having a first end secured to said respective base and a second end, said rods oriented generally perpendicular to said respective bases with said second ends of said rods of each base facing in opposite directions; a feed head, said feed head reciprocally moveable back and forth longitudinally and generally parallel along said rod banks, when removing in a first direction, said feed head applying the flexible material about the exterior surfaces of said rods of one of said rod banks, when moving in a second opposite direction said feed head applying the flexible material about the exterior surfaces of said rods of the other of said rod banks to thereby apply sequential layers of the flexible material to the exterior surface of the rods of said first and second rod banks in an alternating fashion, said sequential layers of flexible material secured to one another at points of contact along the length of said rods to form elongate, generally parallel, conjoined, cellular compartments such that successive rows of conjoined compartments form a panel.

In a further aspect the invention provides an apparatus for the manufacture of a panel of individual cellular compartments from an elongate sheet of flexible material, the apparatus comprising an upper and a lower rod bank, each of said rod banks including a generally horizontal base and a plurality of parallel and vertically oriented rods, said rods generally equally spaced apart and arranged adjacently in a row along each respective base, said rods having a first end secured to said respective base and a second end, said second ends of said rods of each base facing in opposite directions; a feed head, said feed head reciprocally moveable back and forth longitudinally and generally parallel along said rod banks, when removing in a first direction, said feed head applying the flexible material about the exterior surfaces of said rods of one of said rod banks, when moving in a second opposite direction said feed head applying the flexible material about the exterior surfaces of said rods of the other of said rod banks to thereby apply sequential layers of the flexible material to the exterior surface of the rods of said upper and lower rod banks in an alternating fashion, said sequential layers of flexible material secured to one another at points of contact along the length of said rods to form elongate, generally parallel, conjoined, cellular compartments such that successive rows of conjoined compartments form a panel.

Further aspects of the invention will become apparent from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper side perspective view of an example of a panel formed from individual cellular compartments utilizing the present invention.

FIG. 2 is an upper perspective view of an apparatus in accordance with an embodiment of the invention, wherein the feed head is in an initial position at the left hand end of the rod banks.

FIG. 3 is an upper side perspective view similar to that shown in FIG. 2 wherein the left roller and the right heat applicator are in their working positions.

FIG. 4 is a view similar and subsequent to that of FIG. 3 wherein the feed head has been moved to the right hand end of the rod banks.

FIG. 5 is a view similar and subsequent to that of FIG. 4 wherein the left roller and the right heat applicator have been moved to their waiting or standby position and the right roller and the left heat applicator are in their working positions, with the rod banks beginning their reciprocal movement with the lower rod bank being moved behind the upper rod bank and the upper rod bank being moved in front of the lower rod bank, the rollers and heat applicators being in their standby positions.

FIG. 6 is a view similar and subsequent to that of FIG. 5 wherein the reciprocal movement of the rod banks has been further advanced.

FIG. 7 is a view similar and subsequent to that of FIG. 6 wherein the movement of the rods banks has been completed with the lower rod bank now behind the upper rod bank.

FIG. 8 is a view similar and subsequent to that of FIG. 7 wherein the right roller and the left heat applicator are in their working positions.

FIG. 9 is a view similar and subsequent to that of FIG. 8 wherein the feed head has moved laterally across the rod banks toward its initial starting position and the left hand end of the rod bank.

FIG. 10 is a view similar and subsequent to that of FIG. 9 wherein both of the rollers and heat applicators are in their standby positions.

FIG. 11 is a view similar and subsequent to that of FIG. 10 wherein the rod banks are being moved to reverse their relative positions.

FIG. 12 is a view similar and subsequent to that of FIG. 11 wherein movement of the rods banks has been completed and the apparatus has effectively returned to the position shown in FIG. 2.

FIG. 13 is an enlarged schematic view of a portion of the apparatus shown in FIG. 2 depicting the two rod banks, a portion of the left roller and a portion of the right heat applicator in their working positions, similar to that shown in FIG. 3, and applying an elongate sheet of flexible material to the adjacent rod bank.

FIG. 14 is a plan schematic view of the left roller and right heat applicator shown in FIG. 13 depicting the manner of application of the flexible material to the rod bank.

FIG. 15 is a view similar and subsequent to that as shown in FIG. 13 depicting the application of the flexible material to the rod bank from left to right.

FIG. 16 is a view similar and subsequent to that shown in FIG. 15 wherein the feed head has moved laterally to the right hand end of the rod banks.

FIG. 17 is a view similar and subsequent to that as shown in FIG. 16 wherein the roller and heat applicator have been withdrawn from contact with the rod bank and wherein the rod banks have begun their cyclical motion.

FIG. 18 is a view similar and subsequent to that as shown in FIG. 17 wherein the cyclical movement of the rod banks has been further advanced.

FIG. 19 is a view similar and subsequent to that as shown in FIG. 18 wherein the upper rod bank has now been moved to a position in front of the lower rod bank.

FIG. 20 is a view similar and subsequent to that as shown in FIG. 19 wherein the upper rod bank is fully in front of the lower rod bank with the two rod bank bases being drawn into closer proximity with each other.

FIG. 21 is a view similar and subsequent to that as shown in FIG. 20 wherein the cyclical movement of the two rod banks has been completed.

FIG. 22 is a view similar and subsequent to that as shown in FIG. 21 wherein the right roller and the left heat applicator are in their working position and the elongate sheet of flexible material is being applied to the surface of the upper rod bank in a direction moving from right to left.

FIG. 23 is a view similar and subsequent to that as shown in FIG. 22 wherein the feed head has moved further from right to left with the sheet of flexible material applied to the exterior surface of the rods of the upper rod bank.

FIG. 24 is view similar and subsequent to that as shown in FIG. 23 wherein the feed head has moved across the face of the rod bank to its left end.

FIG. 25 is a view similar and subsequent to that shown in FIG. 24 wherein the right roller and the left heat applicator are in their standby position and the lower rod bank is being moved vertically downward and away from the upper rod bank.

FIG. 26 is a view similar and subsequent to that shown in FIG. 25 wherein the lower rod bank has been fully separated from the upper rod bank in a vertical plane.

FIG. 27 is a view similar and subsequent to that as shown in FIG. 26 wherein the lower rod bank has been moved horizontally in front of the upper rod bank.

FIG. 28 is a view similar and subsequent to that as shown in FIG. 27 wherein the lower rod bank has been moved upwardly toward the upper rod bank.

FIG. 29 is a view similar and subsequent to that as shown in FIG. 28 wherein the rod banks have returned to their position shown in FIG. 13, and wherein the feed head is ready to begin movement again from left to right to apply a further layer of the flexible material to the exterior surface of the rods of the lower rod bank.

### DESCRIPTION

The present invention may be embodied in a number of different forms. The specification and drawings that follow describe and disclose some of the specific forms of the invention.

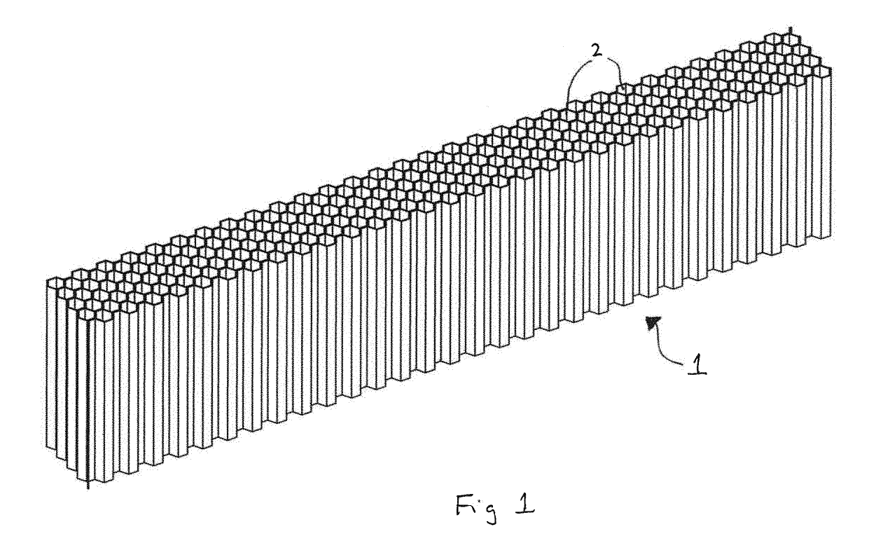

In the attached drawings, FIG. 1 shows a representative form of the panel 1 constructed from a series of adjacent, individual cellular compartments 2. Panel 1 represents but one type of such panel that may be created utilizing the apparatus of the present invention. In FIG. 1, the depicted panel is shown as comprised of a series of adjacent, longitudinal, cellular compartments 2 that are generally hexagonal in cross-section. The particular form of panel is thus provided with a generally honeycomb shape when viewed from either its top or bottom surface. It will, however, be appreciated that panels formed from cellular compartments of alternate cross-sectional shapes and sizes could equally be constructed. Further, panels of a variety of different dimensions could be constructed. The particular panel shown has a depth of several inches (in this instance approximately 6″) and a width and length of several feet. As mentioned, panels similar to those shown in FIG. 1 would typically be filled with foam and/or resin and/or other materials to form a rigid or semi-rigid panel structure. The upper and lower surfaces of the core shown in FIG. 1 could also be covered with protective coatings, sheets or resinous materials to further enhance the physical properties of the overall panel.

From an understanding of the invention as described in the paragraphs that follow, it will also be appreciated that the core shown in FIG. 1 is constructed from an elongate sheet of flexible material or stock that is formed into the honeycomb structure depicted. In this particular instance, the flexible material is of a fibrous nature and, in one embodiment, is preferably heat bondable. Other forms of flexible material could also be utilized.

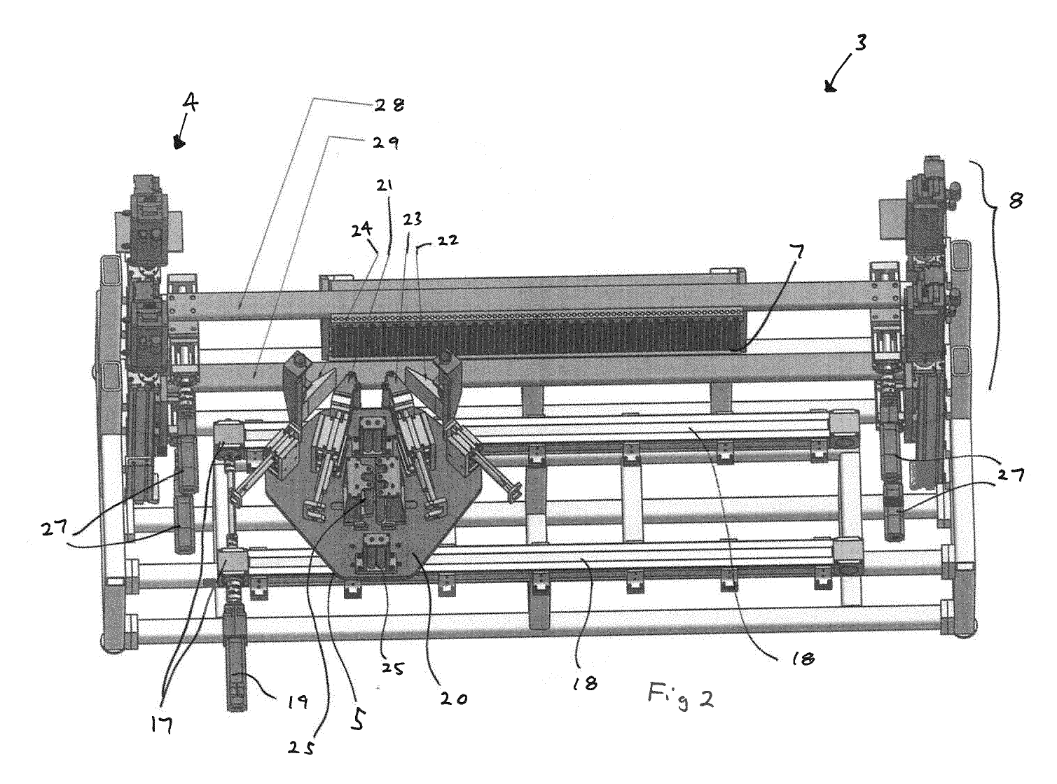

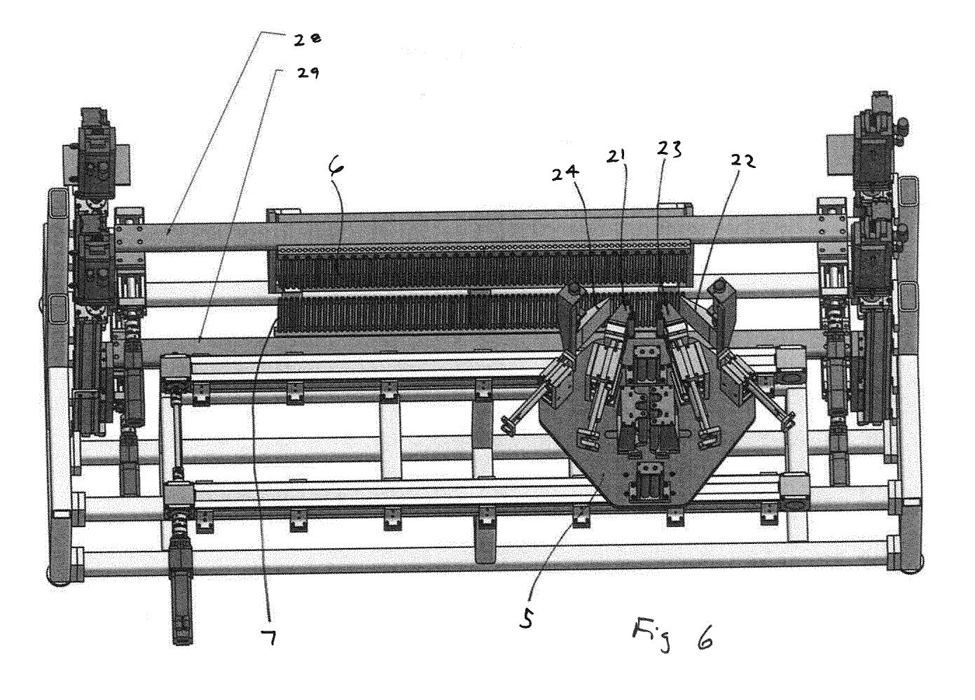

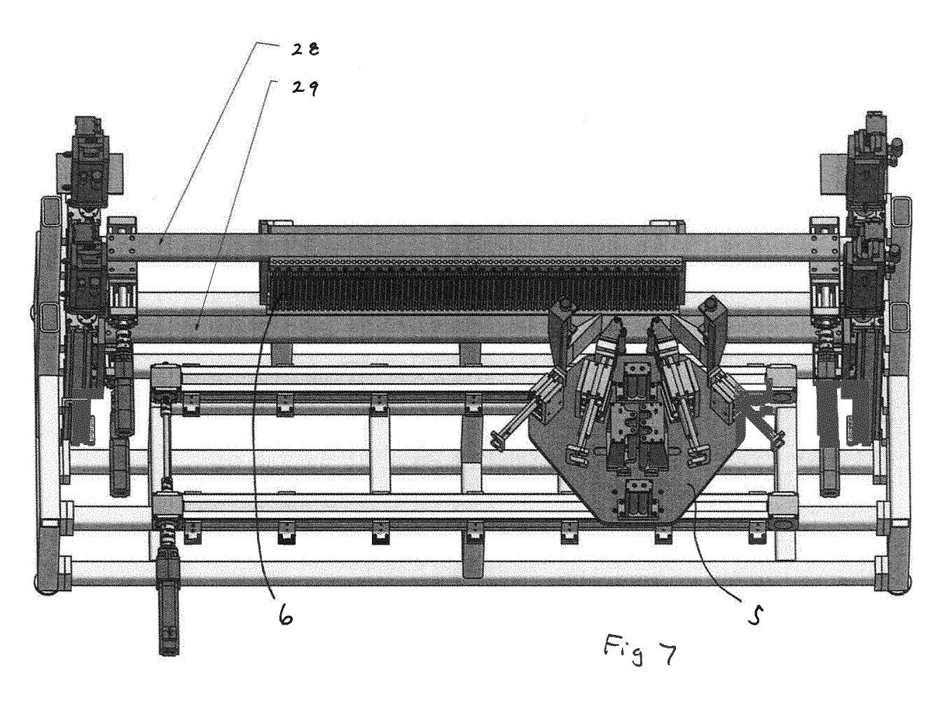

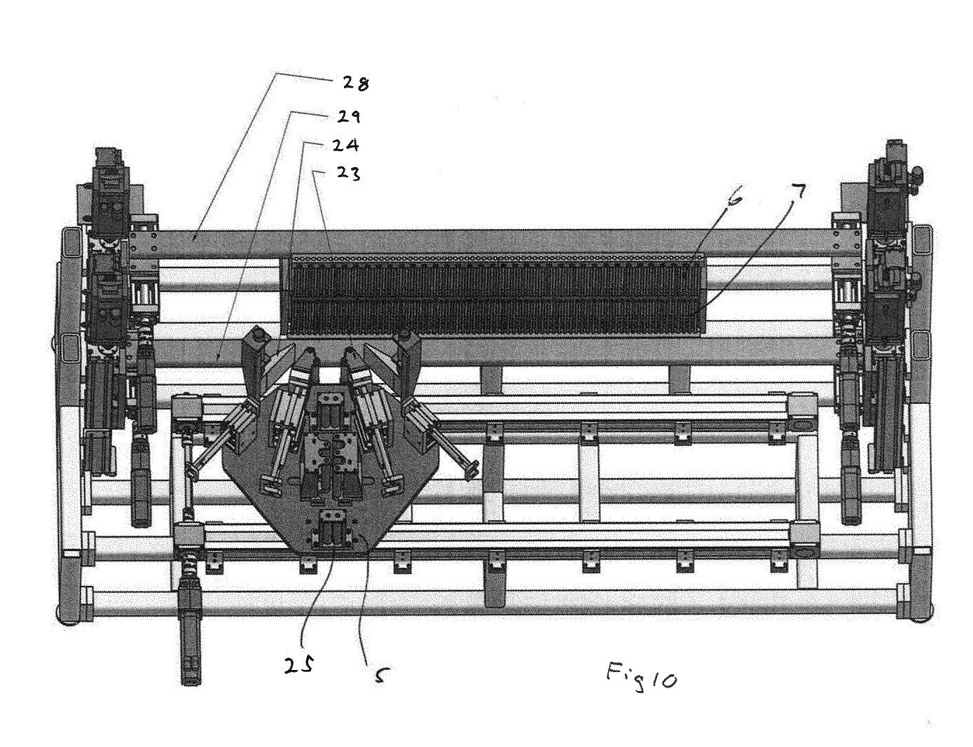

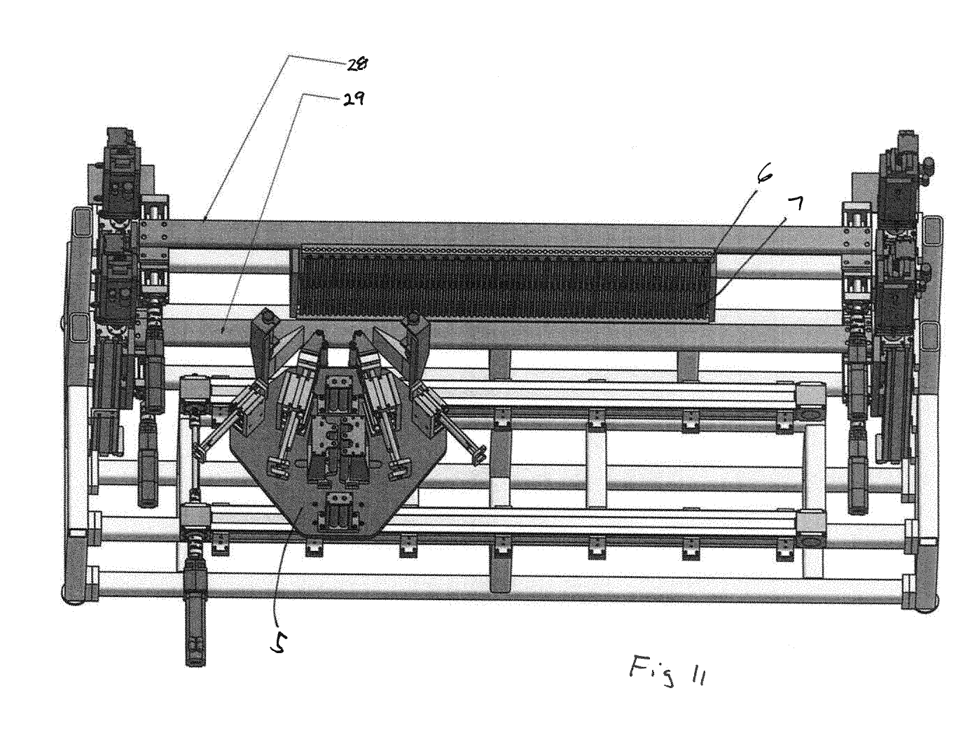

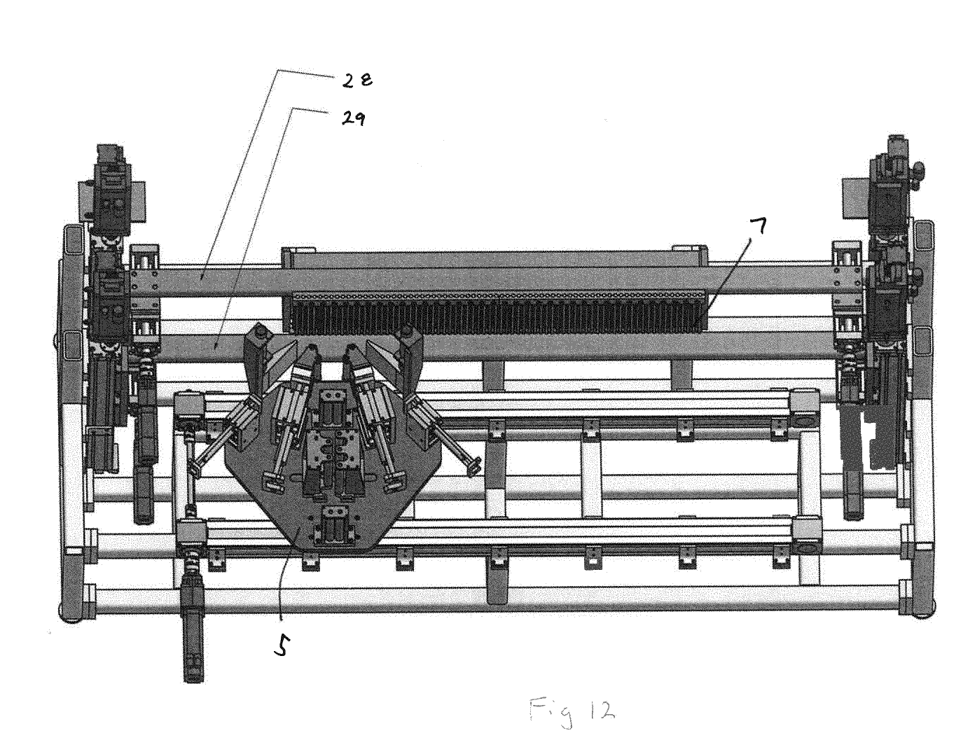

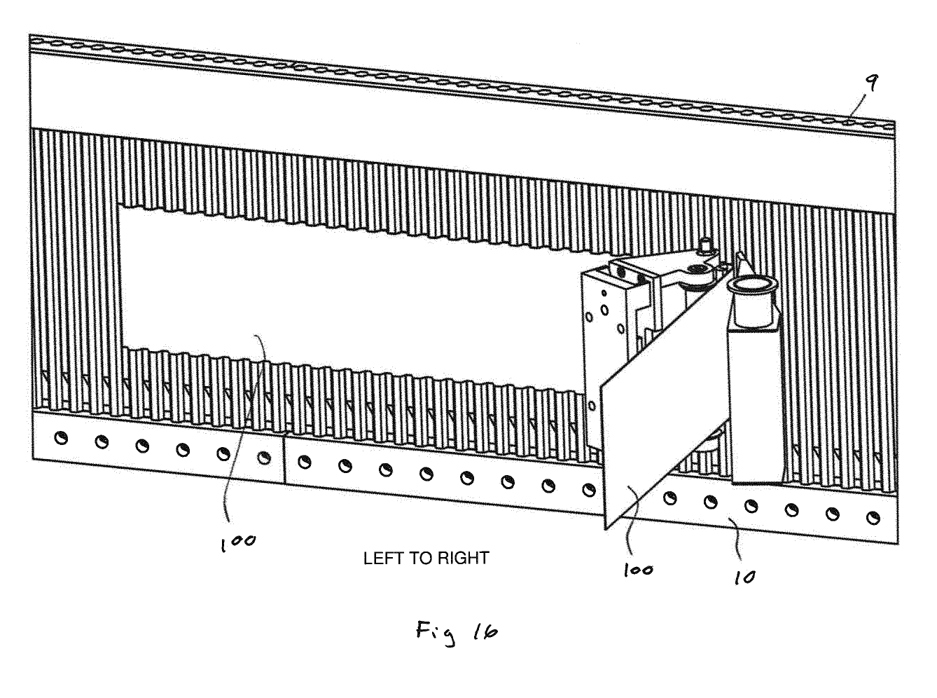

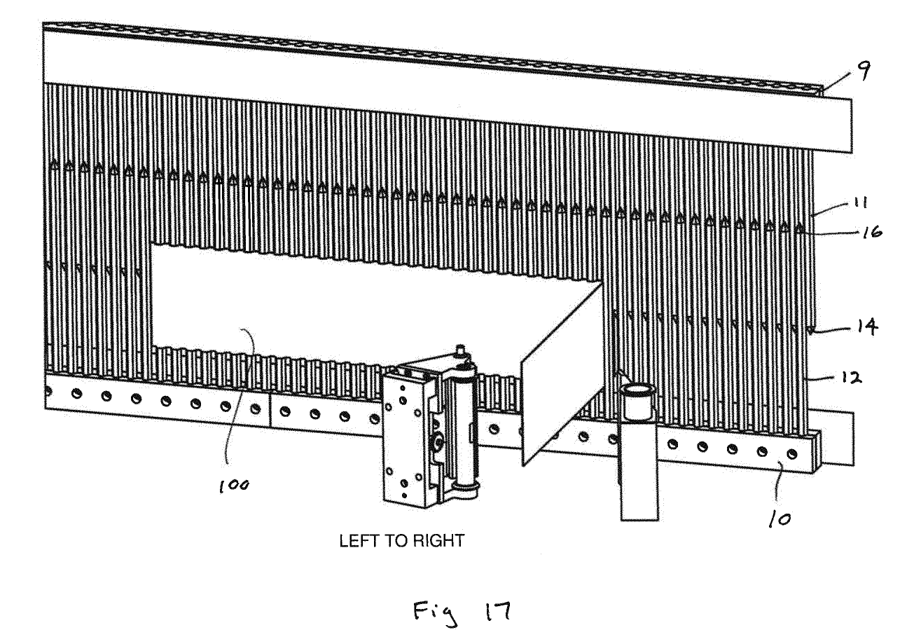

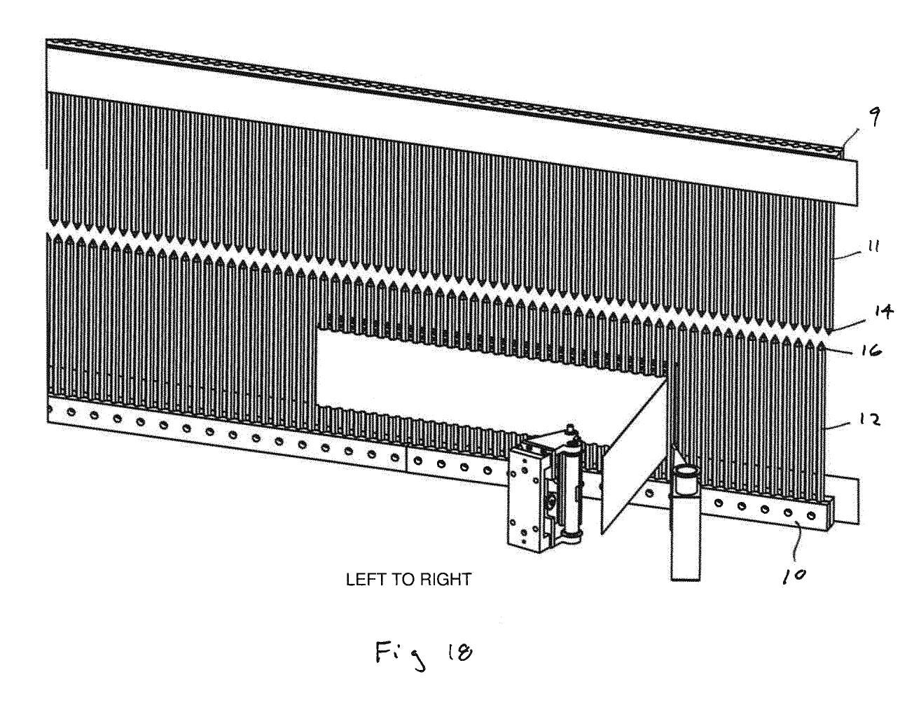

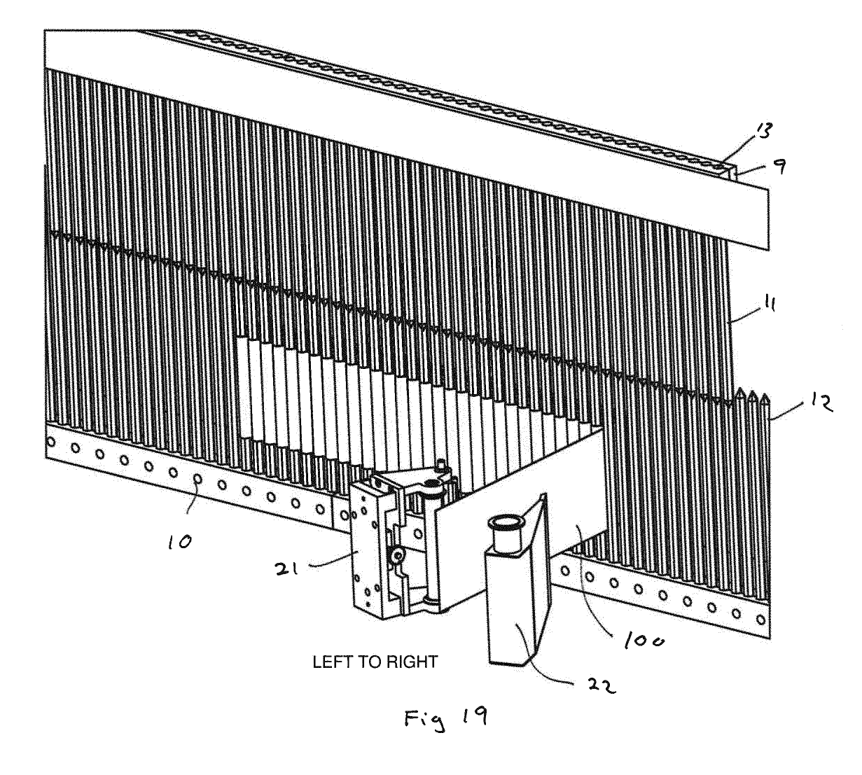

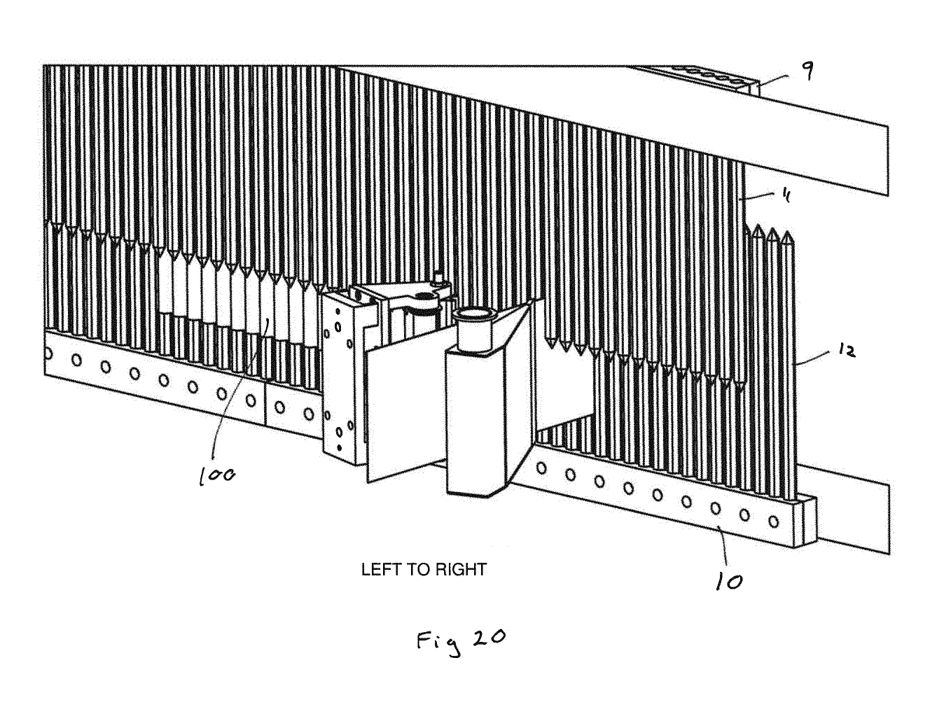

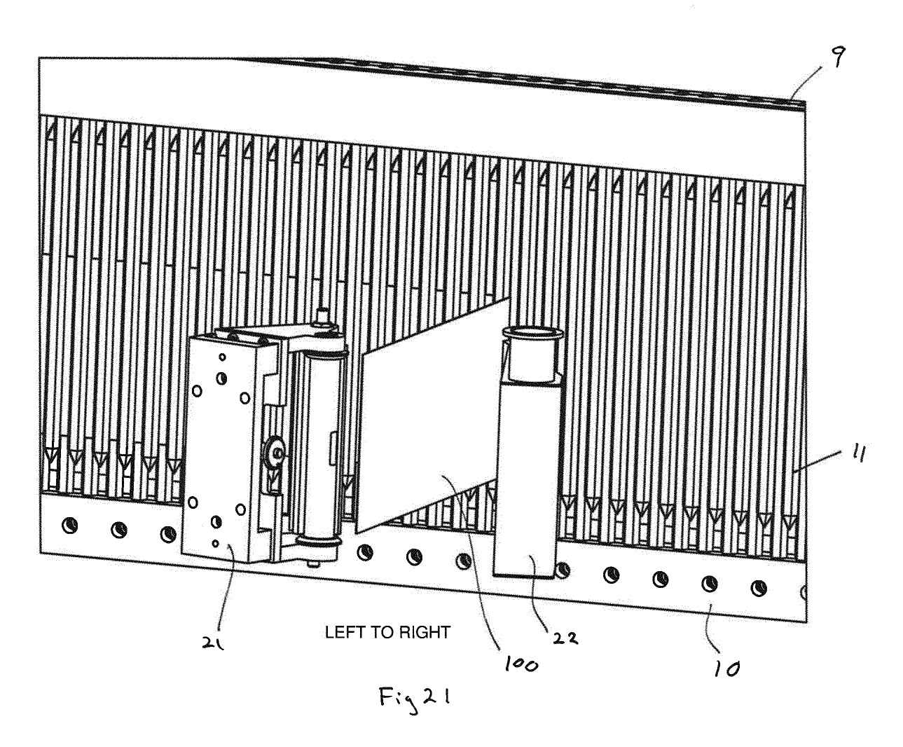

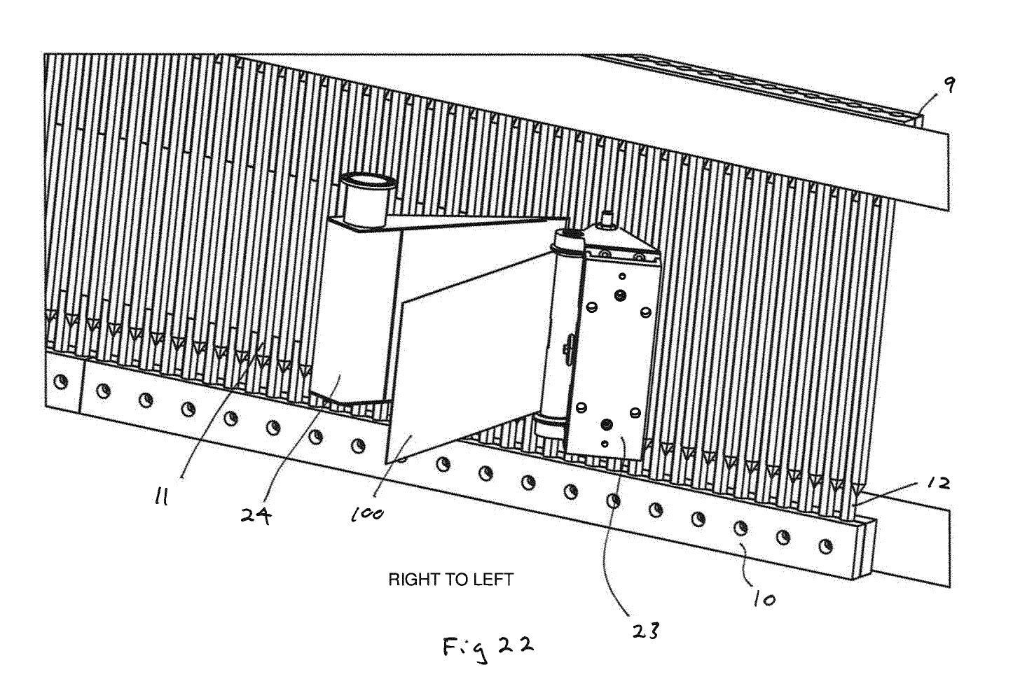

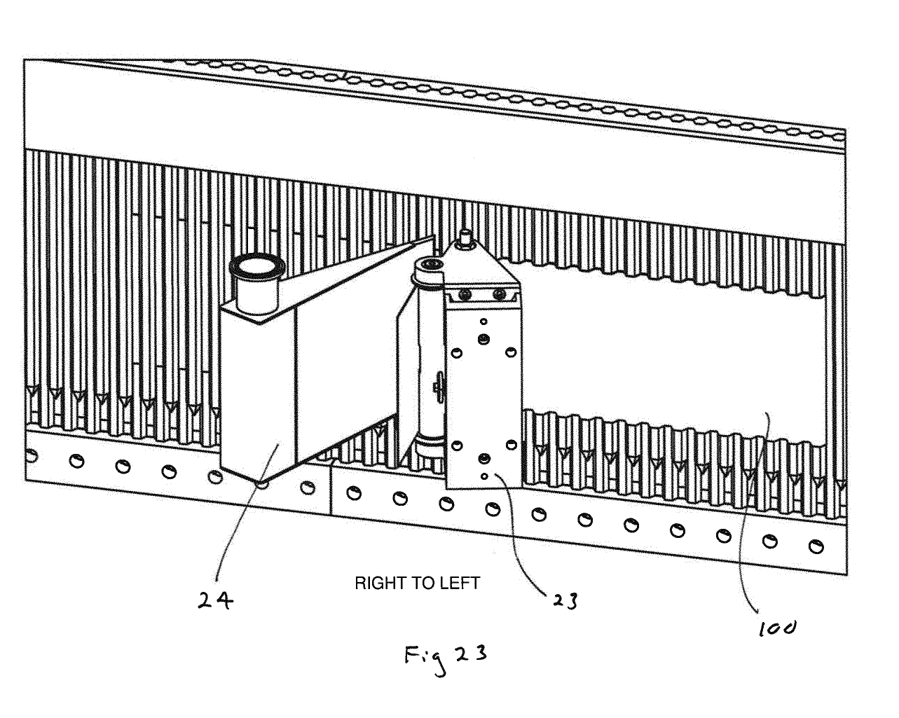

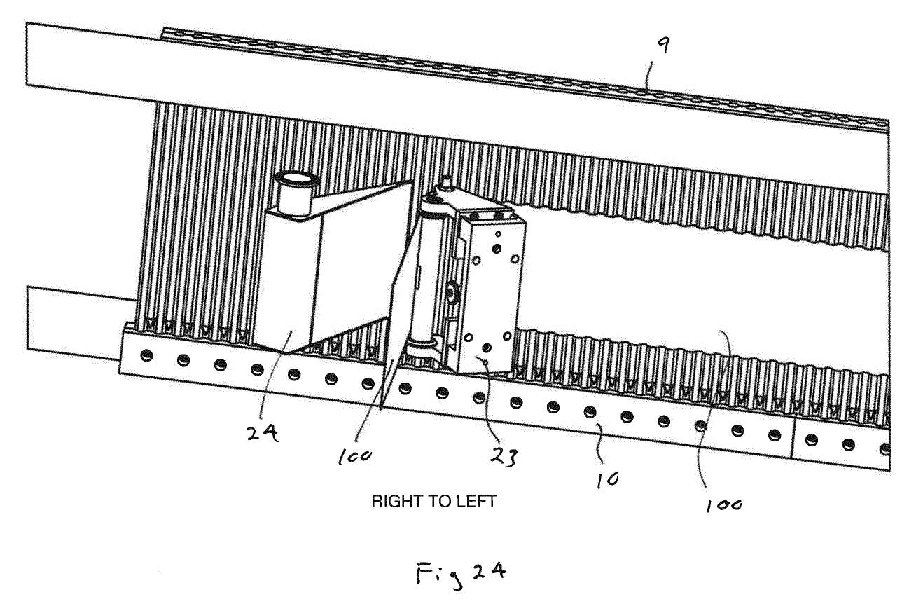

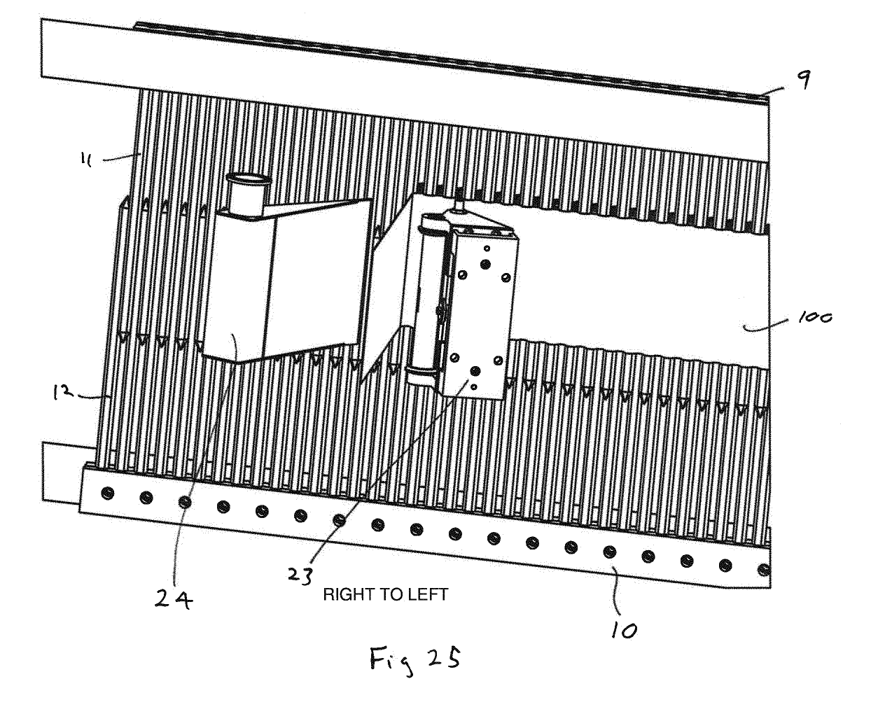

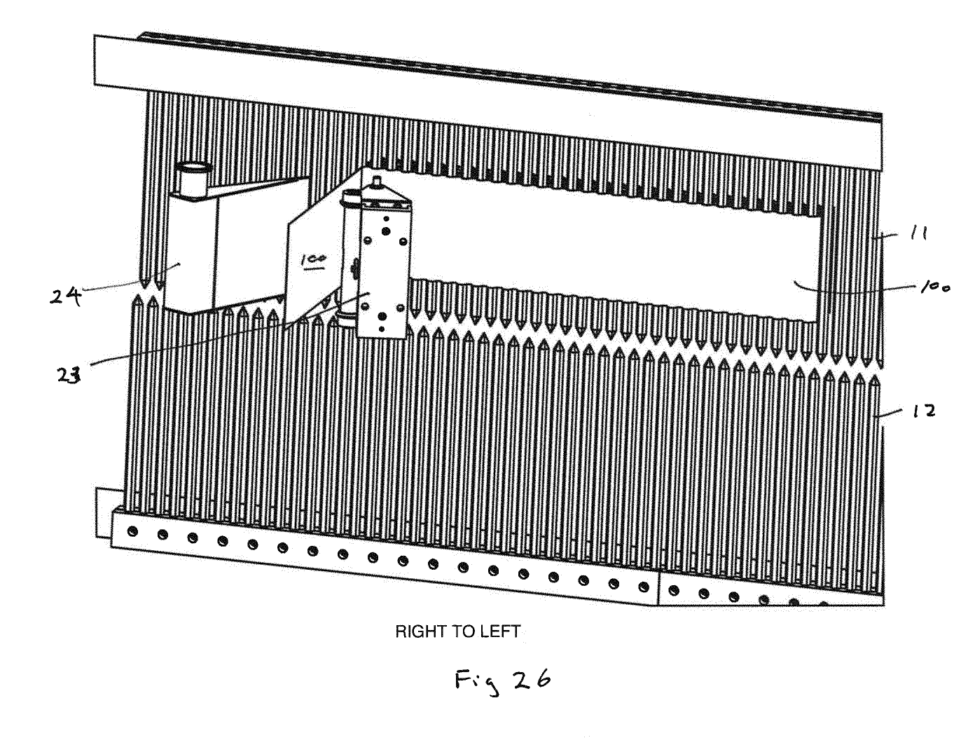

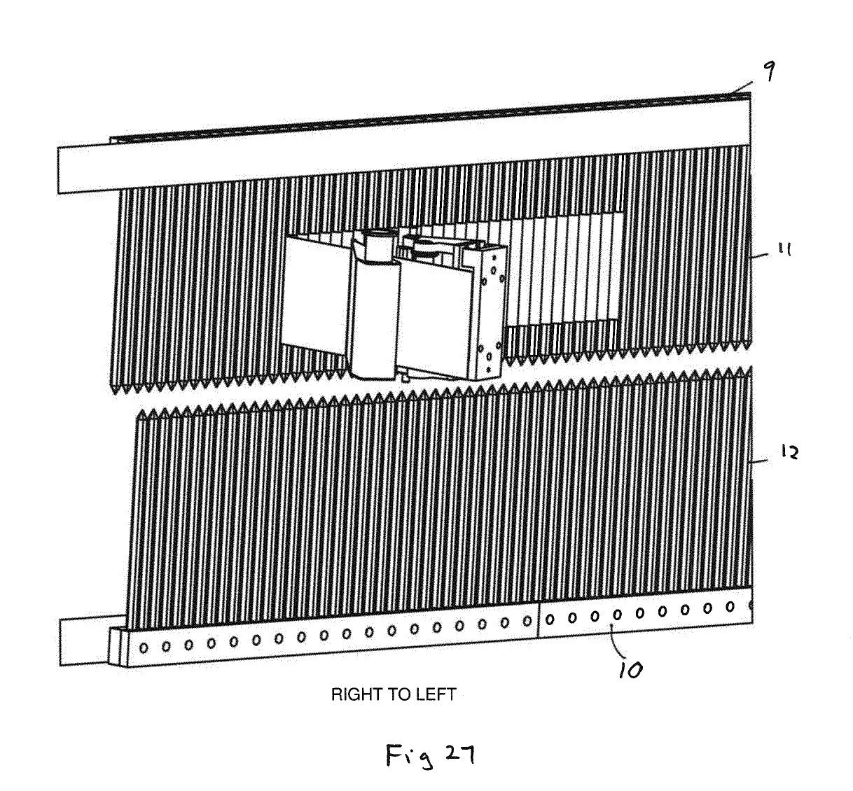

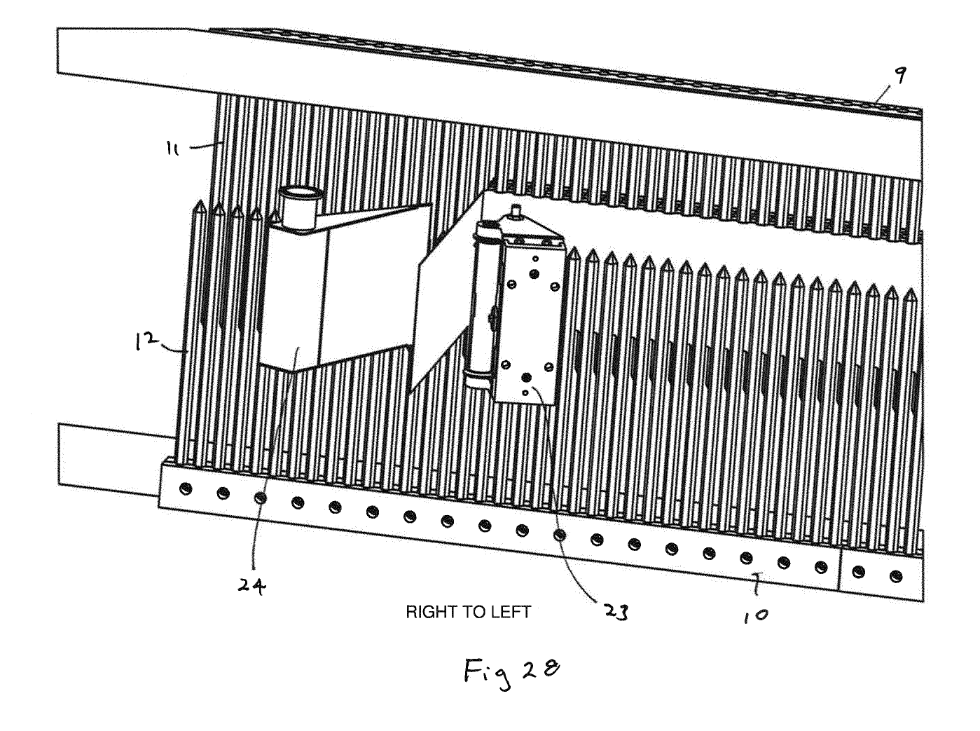

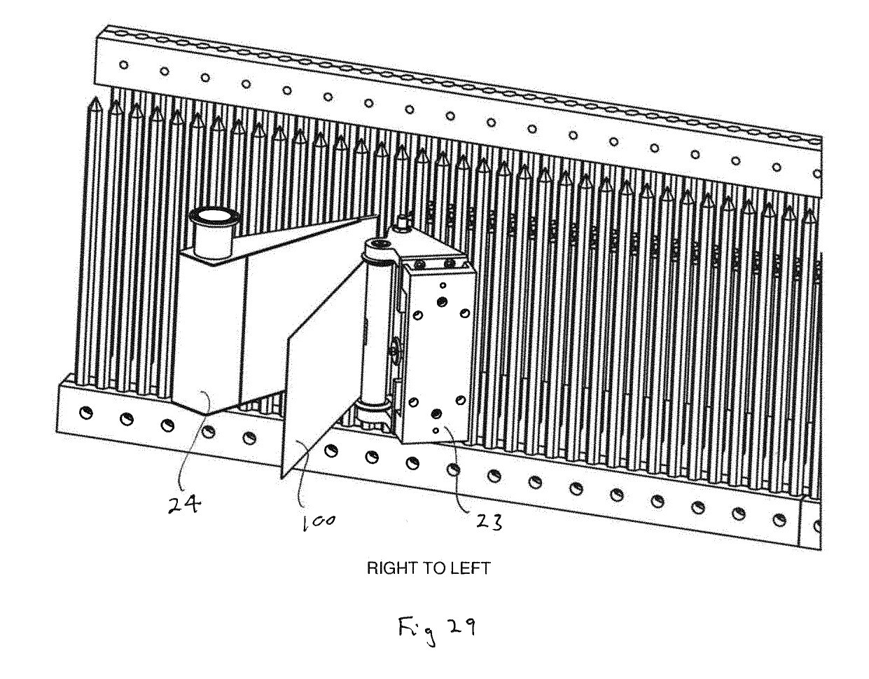

The structure and operation of an apparatus constructed in accordance with an embodiment of the invention will now be described in future detail with reference to FIGS. 2 through 29.

Throughout the attached figures, there is shown an embodiment of an apparatus 3 used for the manufacture of a panel of individual cellular compartments from an elongate sheet of flexible material 100, an example of such a panel being shown in FIG. 1. It will be appreciated that apparatus 3 will be constructed from a number of different individual components. In general terms, apparatus 3 is formed from a drive mechanism 4 and a feed head 5. Drive mechanism 4 will itself be constructed of a large number of individual components, however, the primary components of the drive mechanism comprise first and second rod banks 6 and 7 and a rod bank cycling mechanism 8. First rod bank 6 may at times be referred to as an upper rod bank, whereas second rod bank 7 may at times be referred to as a lower rod bank. Each rod bank includes a base (9 and 10 respectively). In turn, each base includes a plurality of elongate and parallel rods, arranged adjacently in a row along each base and generally equally spaced apart from one another. Rods 11 of first or upper rod bank 6 have a first end 13 secured to base 9, and further have a second end 14 that extends in a direction opposite base 9. Similarly, rods 12 of lower rod bank 7 include a fixed end 15 that is secured to base 10 and an outer, opposite, end 16 directed away from base 10.

As shown in the attached drawings, bases 9 and 10 are themselves elongate with their respective rods arranged in a row along their longitudinal axis. Further, bases 9 and 10 are oriented in a spaced apart and generally parallel relationship to one another. Rods 11 and 12 are oriented generally perpendicularly to their respective bases with the second or outer ends of the rods of each base facing in opposite directions. As will become more apparent from a thorough understanding of the invention, rod bank cycling mechanism 8 is used to repeatedly move the first and second rod banks through a first and then a second cycle to permit the application of flexible material alternately to the rods of each respective bank.

One particular embodiment of apparatus 3 and its operation will now be discussed in further detail with specific reference to the attached figures. In the attached figures, apparatus 3 is configured to construct a panel 1 in a generally horizontal plane. To that end, bases 9 and 10 are generally horizontally oriented with first rod bank 6 comprising an upper rod bank and second bank 7 comprising a lower rod bank. Rod bank cycling mechanism 8 is also a generally horizontally configured structure to cycle the upper and lower rod banks through their various positions. In this configuration, feed head 5 is reciprocally movable back and forth, longitudinally and generally horizontally, along and parallel to the rod banks. The feed head is moved through the use of a feed head drive mechanism 17 that is comprised generally of a set of parallel rails 18 to which a feed head platform 20 is movably secured. In this instance, a linear actuator 19 drives the feed head horizontally in a reciprocal manner back and forth along the rod banks. It will, however, be appreciated that other forms of drive mechanisms could equally be used to accomplish the same function.

As feed head 5 is moved along the rod banks, the feed head will apply the flexible material about the exterior side surfaces of the rods of one of the rod banks. When the feed head is moved in the opposite direction, it will apply the flexible material about the exterior surface of the rods of the other rod bank, to thereby apply sequential layers of the flexible material about the exterior surface of rods of the first and then the second rod banks in an alternating fashion. To accomplish such an application of flexible material, feed head 5 includes a first toothed roller 21 and a first adhesive applicator/heat applicator 22, together with a second tooth roller 23 and a second adhesive applicator/heat applicator 24. The choice of whether an adhesive applicator or heat applicator is utilized will depend upon the nature of the flexible material that is being applied about the surface of the rods.

As sequential layers of flexible material are applied to the rods, there will be points of contact between each adjacent layer in (in this instance) a vertical direction. In some instances the application of an adhesive to the flexible material along such points of contact will be required in order to cause the material to adhere together forming elongate, generally parallel, conjoined, cellular compartments that ultimately form panel 1. In other instances, the flexible material may be a heat sealable material such that a heat applicator, as opposed to an adhesive applicator, may be utilized. In those instances, the heat applicator can apply heat (most commonly) through directing heated air to the flexible material in order to raise the temperature of the material at the points of contact to a sufficient level to cause a heat bonding or heat welding.

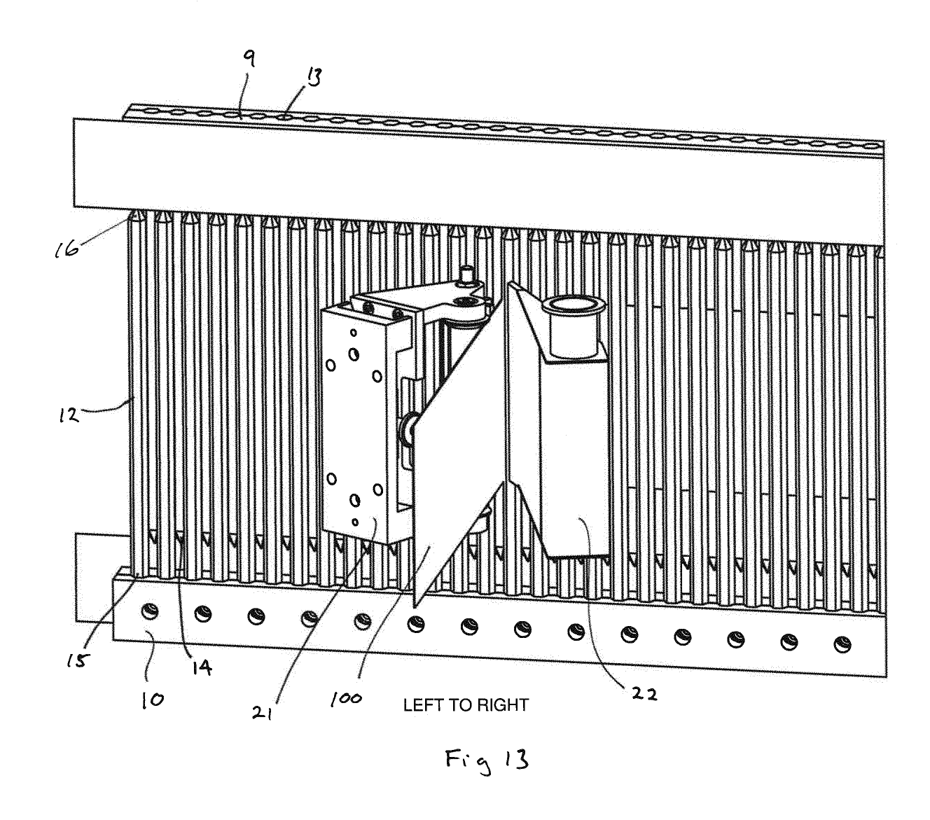

Feed head 5 will also preferably include a series of rollers 25 that will direct the flexible material through the feed head in an appropriate manner to enable the feed head to apply the material to the surface of one of the rod banks. Rollers 25 also help to maintain the orientation and the tension on the flexible material, which would typically be stored on a large roll (not shown) situated adjacent to apparatus 3. It should be noted that for ease of comprehension, the flexible material has been eliminated from FIGS. 2 through 12. However, flexible material 100 has been included within the schematic FIGS. 13 through 29. It will be further appreciated that each of first and second tooth rollers 21 and 23, each of first and second adhesive applicators/heat applicators 22 and 24, and rollers 25 will be positioned upon feed head platform 20 so that as the feed head is reciprocated back and forth along the length of the rod banks, so are each of its various components.

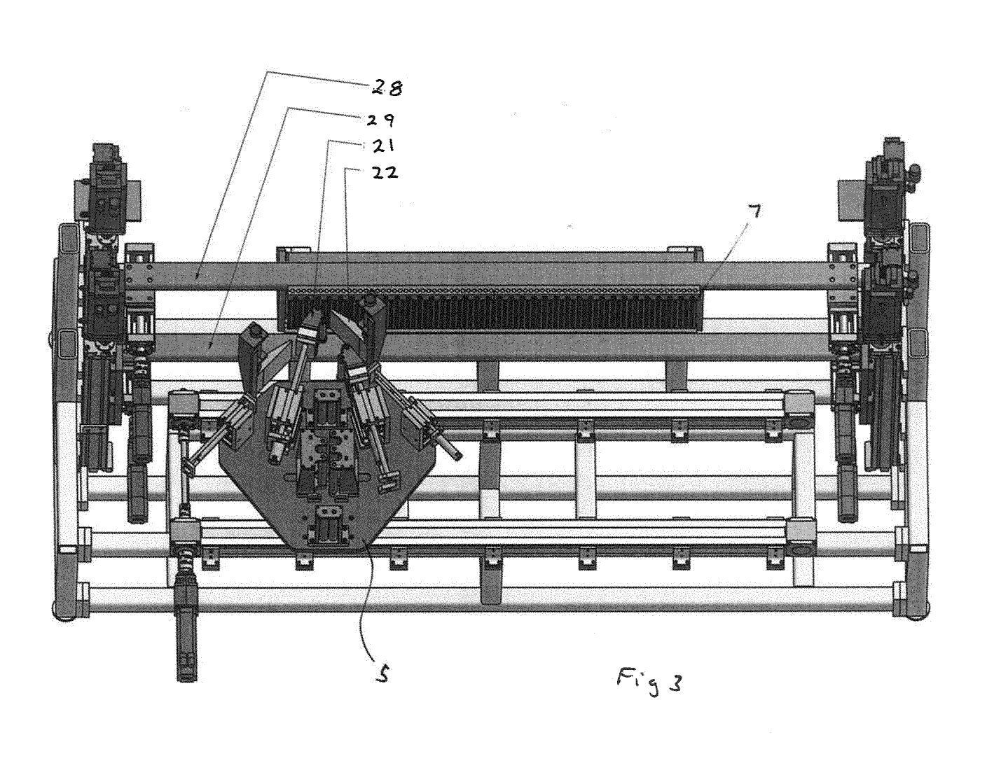

FIG. 3 shows the configuration of the rod banks and the feed head when flexible material is being applied from a left to a right direction. Here first tooth roller 21 and first heat applicator 22 are in an extended or “working” position such that they are immediately adjacent to the rods of lower rod bank 7. Rollers 25 deliver the flexible material to the surface of the rod bank between first tooth roller 21 and first adhesive applicator 22. In this manner, as the feed head is moved from the left to the right end of the rod bank, material is fed through rollers 25 and deposited upon the surface of the rods of the lower rod bank.

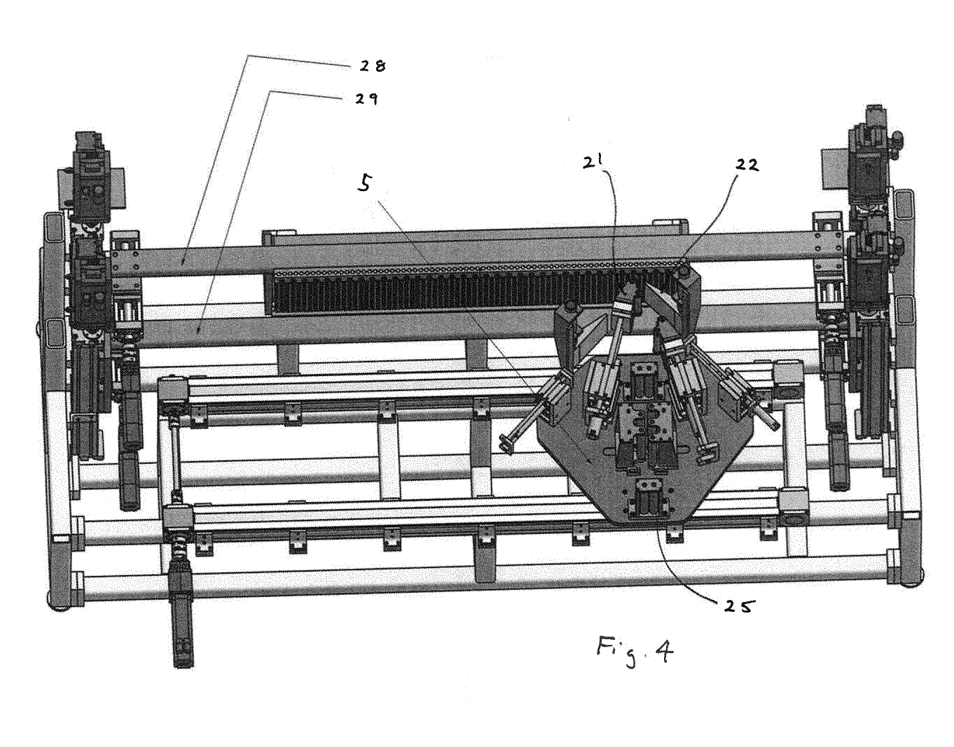

As the feed head is moved parallel to the rod bank, first tooth roller 21 will effectively press the material against the exterior surfaces of the individual rods and force material into the longitudinal spacing between adjacent rods. In the embodiment of the invention depicted in the drawings, the flexible material is a semi-rigid, heat bondable, material, meaning that the first and second adhesive applicators/heat applicators are heat applicators that blow heated air against both the rods and the material to cause the material to be heated to a point where material in contact is heat sealed or heat welded together. The semi-rigid nature of the material permits the material to generally retain the shape of the exterior surface of the rods after being pressed against the rods by the toothed roller. FIG. 4 shows the feed head at the end of its movement at the right hand end of the rod bank.

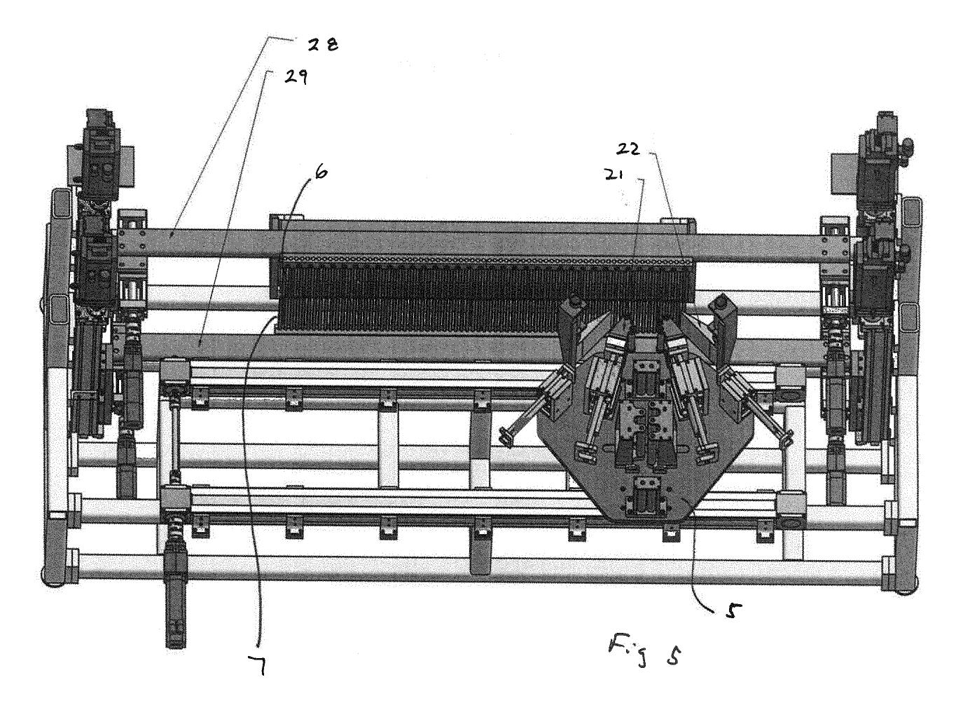

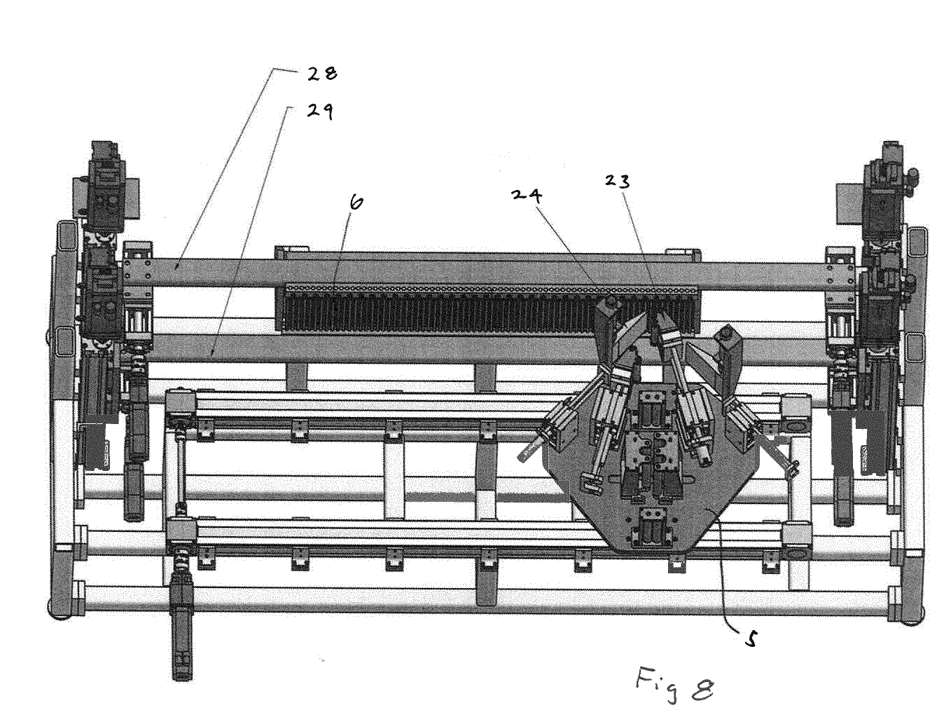

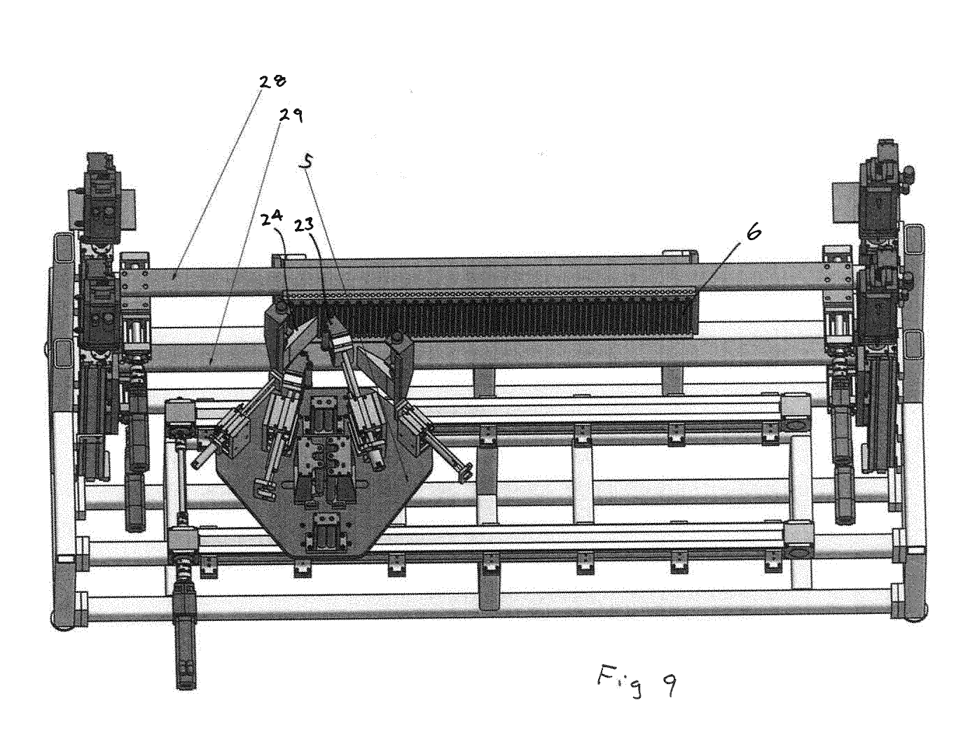

With reference to FIG. 5, it will be noted that the first tooth roller 21 and the first heat applicator 22 have been withdrawn from their working positions (wherein they are adjacent to the rods of the lower rod bank) to a waiting or “standby” position, retracted onto the feed head. At that point, rod bank cycling mechanism 8 is activated to cycle the rod banks through their various positions as shown in FIG. 5 though 7. To that end, upper rod bank 6 is initially lifted to separate the rod banks vertically. The upper rod bank is then moved horizontally forward toward the feed had as the lower rod bank is moved horizontally away from the feed head. The upper rod bank is then lowered to the point where its rods 11 are in front of rods 12 of lower rod bank 7. Second tooth roller 23 and second heat applicator 24 are then moved forwardly into their working positions adjacent to the exterior surface of rods 11 of upper rod bank 6. Feed head 5 can then be moved laterally along the face of the rod bank from a right to a left direction as second toothed roller 23 serves to apply the flexible material to the exterior surfaces of rods 11 until feed head 5 eventually reaches the left hand end of the rod bank (see FIGS. 8 and 9). Once the feed head has returned to its position at the left hand end of the rod banks, apparatus 1 will effectively have applied two adjacent layers of flexible material about the rods of the respective upper and lower rod banks.

The operation of the toothed rollers will not only form the flexible material about the exterior surfaces of the rods to effectively create cellular compartments 2, but will also cause adjacent layers of the flexible material to come into contact at the points where they can be bonded together (in this case, through the application of heat). Once the feed head has returned to the left hand end of the rod banks, second toothed roller 23 and second heat applicator 24 will be withdrawn into their waiting or standby positions to once again permit the rod banks to cycle through their respective movement. That movement will generally involve lower bank 7 being moved in a downward direction and away from upper rod bank 6, until the outer ends 16 of the rods 12 of lower rod bank 7 clear the outer ends 14 of rods 11 of the upper rod bank 6. The lower rod bank is then moved outwardly toward feed head 5 and upper rod bank 6 is moved rearwardly away from feed head 5, after which the lower rod bank 7 is elevated to permit its rods 12 to be located horizontally in front of the rods of upper rod bank 6. The position of the rod banks and the feed head will at that point be returned to that of the starting position of apparatus 3 as shown in FIG. 2. The movement of feed head 5, the application of flexible material to the exterior surfaces of the rods of the respective rod banks, and the cycling of the rod banks can then be successively repeated in order to apply adjacent rows of flexible material to the rods, wherein the material is adhered together along points of contact to ultimately form a panel from elongate and parallel cellular compartments.

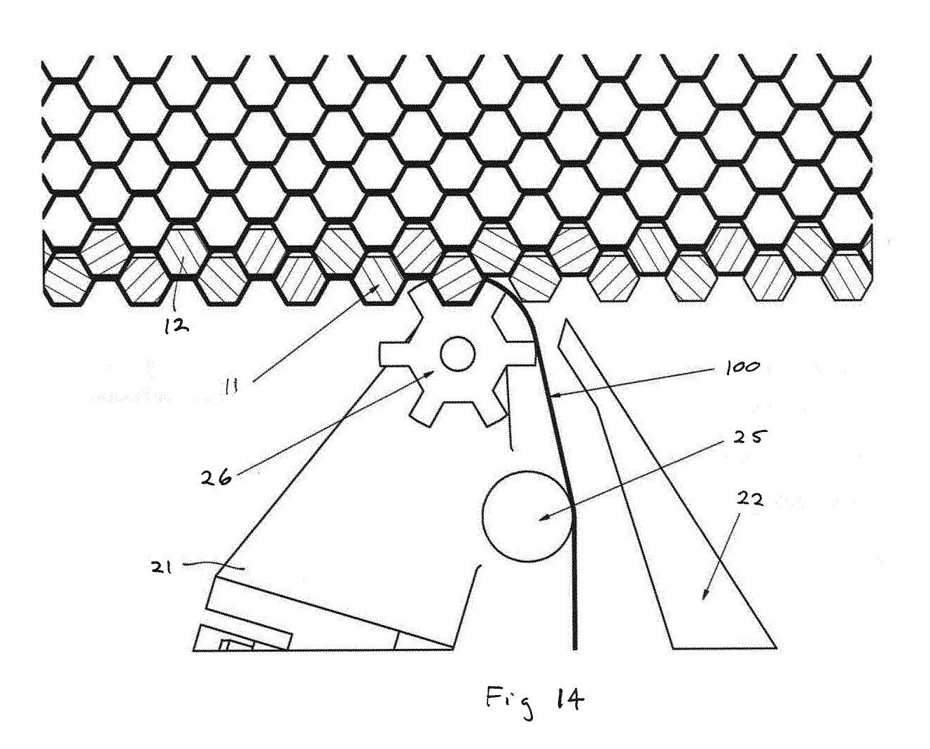

FIG. 14 is a schematic plan view of a number of the rods of the two rod banks and showing the application of flexible fabric through the use of toothed roller 21. Here, it will be appreciated that tooth roller 21 includes a generally vertically oriented star-type roller 26. FIG. 14 also depicts the individual rods of the upper end lower rod banks being hexagonal in cross-section such that the application of flexible material 100 to the exterior of the rods creates successive rows of cellular compartments 2 having a hexagonal cross-section. It will, however, be appreciated that rods 11 and 12 could potentially have other cross sectional shapes while staying within the limits of the invention. For example, rods 11 and 12 could alternately be circular or octagonal in cross section. Other shapes may also be possible. FIG. 14 also demonstrates that although the rows of rods 11 and 12 are parallel, individual rods of one rod bank are offset horizontally relative to the rods of the adjacent rod bank such that the rods of one rod bank effectively align with the spaces between the rods of the adjacent bank. It will also be appreciated upon an examination of FIG. 14 that the net effect of the offsetting the rods in that manner creates an overall generally honeycomb configuration for panel 1.

As mentioned, feed head 5 is preferably moved laterally along the face of the rod banks through the use of linear actuators 19. In a similar manner, the cycling of the upper and lower rod banks between their various positions may be carried out through the use of a series of linear actuators or servo drive systems that move a pair of rod bank rails 28 and 29 that cause the upper and lower rod banks to cycle in their desired manner. Alternately, the rod bank cycling mechanism may be a cam drive system. Preferably, the movement of all of the component parts (including the cycling of the rod banks, the movement of the drive head and the movement of the first and second tooth rollers and first and second adhesive applicators/heat applicators) is controlled through a microprocessor control that can be programmed according to a desired speed, for use with a particular form of flexible material, etc.

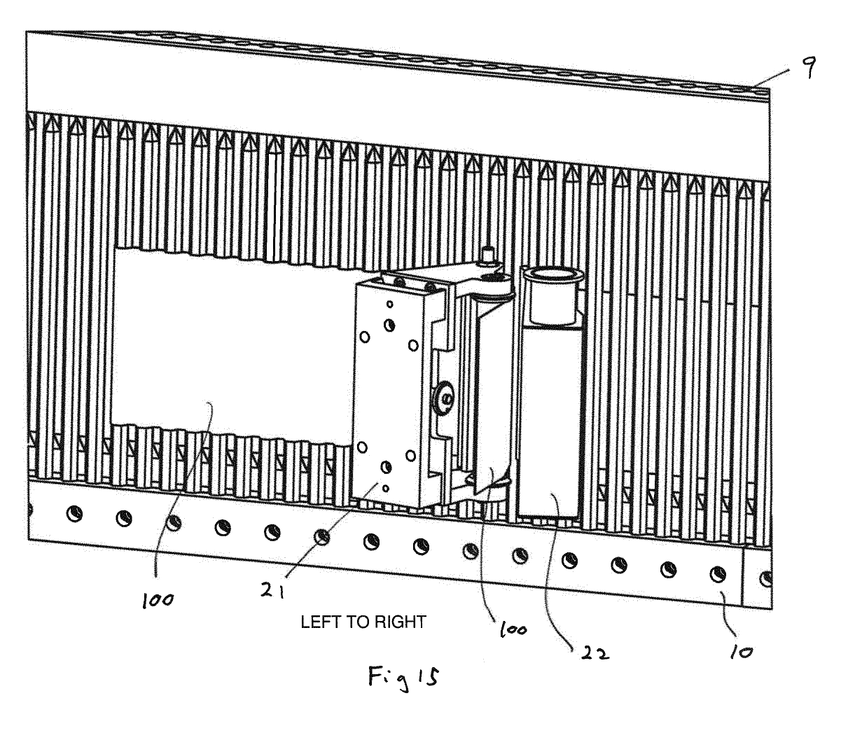

FIGS. 15 through 29 depict schematically the application of flexible material 100 to the surface of the rod banks in a manner consistent with that shown in FIGS. 3 through 12.

Accordingly, there is provided an apparatus that is used in the manufacture of a panel of individual cellular compartments from an elongate sheet of flexible material. Through the use of rods 11 and 12 of a consistent size, apparatus 3 is capable of producing adjacent cellular compartments having a consistent size and configuration. Apparatus 3 is sufficiently automated to permit the construction of panel 1 with little supervision or human intervention. Its microprocessor control permits the operating parameters and speed of the apparatus to be readily modified or changed.

It is to be understood that what has been described are the preferred embodiments of the invention. The scope of the claims should not be limited by the preferred embodiments set forth above, but should be given the broadest interpretation consistent with the description as a whole.

I claim:

1. An apparatus for the manufacture of a panel of individual cellular compartments from an elongate sheet of flexible material, the apparatus comprising:
first and second rod banks, each of said rod banks including a base and a plurality of elongate and parallel rods, said bases oriented in a spaced apart and generally parallel configuration, said rods arranged adjacently in a row along each respective base and generally equally spaced apart from one another on said respective base, said rods having a first end secured to said respective base and a second end, said rods oriented generally perpendicular to said respective bases with said second ends of said rods of each base facing in opposite directions;
a feed head, said feed head reciprocally moveable back and forth longitudinally and generally parallel along said rod banks, when removing in a first direction, said feed head applying the flexible material about the exterior surfaces of said rods of one of said rod banks, when moving in a second opposite direction said feed head applying the flexible material about the exterior surfaces of said rods of the other of said rod banks to thereby apply sequential layers of the flexible material to the exterior surface of the rods of said first and second rod banks in an alternating fashion, said sequential layers of flexible material secured to one another at points of contact along the length of said rods to form elongate, generally parallel, conjoined, cellular compartments such that successive rows of conjoined compartments form a panel.

2. The apparatus as claimed in claim 1 further including a rod bank cycling mechanism to repeatedly move the rod banks through a first and then a second cycle to permit the application of the flexible material alternately to the rods of said first and said second rod banks.

3. The apparatus as claimed in claim 2 wherein said first cycle comprises moving the rods from a position wherein the rods of the respective rod banks are adjacent to one another with the rods of the first bank horizontally in front of the rods of the second bank, to a position wherein the rods of the second rod bank are moved in a direction parallel to and away from the rods of the first rod bank, to a position wherein the rods of the rods banks are moved such that the rods of the second rod bank are horizontally in front of the rods of the first rod bank, to a position wherein the rods of the second rod bank are moved in a direction parallel to and toward the rods of the first rod bank until they are generally adjacent to and horizontally in front of the rods of the first rod bank.

4. The apparatus as claimed in claim 3 wherein said second cycle comprises moving the rods from a position wherein the rods of the respective rod banks are adjacent to one another with the rods of the second bank horizontally in front of the rods of the first bank, to a position wherein the rods of the first rod bank are moved in a direct parallel to and away from the rods of the second rod bank, to a position wherein the rods of the rods banks are moved such that the rods of the first rod bank are horizontally in front of the rods of the second rod bank to a position wherein the rods of the first rod bank are moved in a direction parallel to and toward the rods of the second rod bank until they are generally adjacent to and horizontally in front of the rods of the second rod bank.

5. The apparatus as claimed in claim 2 wherein said bases are generally horizontally oriented and said first rod bank comprises an upper rod bank and said second rod bank comprises a lower rod bank.

6. The apparatus as claimed in claim 2 wherein said rod bank cycling mechanism is a cam drive system.

7. The apparatus as claimed in claim 2 wherein said rod bank cycling mechanism is a linear actuator.

8. The apparatus as claimed in claim 1 wherein said feed head includes a toothed roller to press the flexible material against the rods of an adjacent rod bank and into the spaces between the rods of said rod bank.

9. The apparatus as claimed in claim 8 wherein said feed head includes an adhesive applicator to apply an adhesive to the flexible material causing the flexible material to adhere together at points of contact.

10. The apparatus as claimed in claim 8 wherein the flexible material is a heat sealable material and said feed head includes a heat applicator to heat flexible material that is in contact with adjacent flexible material to cause the flexible material to be fused together along points of contact.

11. The apparatus as claimed in claim 10 wherein said heat applicator is a blower that applies heated air.

12. The apparatus as claimed in claim 2 further including a feed head cycling mechanism, said feed head cycling mechanism reciprocally moving said feed head back and forth along said rod banks.

13. The apparatus as claimed in claim 12 including a microprocessor control to control the movement and feeding of the flexible material by said feed head, and the movement of said rod bank cycling mechanism and said feed head cycling mechanism.

14. The apparatus as claimed in claim 1 wherein said rods are hexagonal in cross section such that the resultingly formed cellular compartments are hexagonal in cross section.

15. An apparatus for the manufacture of a panel of individual cellular compartments from an elongate sheet of flexible material, the apparatus comprising:
an upper and a lower rod bank, each of said rod banks including a generally horizontal base and a plurality of parallel and vertically oriented rods, said rods generally equally spaced apart and arranged adjacently in a row along each respective base, said rods having a first end secured to said respective base and a second end, said second ends of said rods of each base facing in opposite directions;
a feed head, said feed head reciprocally moveable back and forth longitudinally and generally parallel along said rod banks, when removing in a first direction, said feed head applying the flexible material about the exterior surfaces of said rods of one of said rod banks, when moving in a second opposite direction said feed head applying the flexible material about the exterior surfaces of said rods of the other of said rod banks to thereby apply sequential layers of the flexible material to the exterior surface of the rods of said upper and lower rod banks in an alternating fashion, said sequential layers of flexible material secured to one another at points of contact along the length of said rods to form elongate, generally parallel, conjoined, cellular compartments such that successive rows of conjoined compartments form a panel.

16. The apparatus as claimed in claim 15 including a rod bank cycling mechanism to repeatedly move the rod banks through a first and then a second cycle to permit the application of the flexible material alternately to the rods of said first and said second rod banks, and further including a feed head cycling mechanism to reciprocally move said feed head back and forth along said rod banks.

17. The apparatus as claimed in claim 16 wherein said first cycle comprises moving the rods from a position wherein the rods of the respective rod banks are adjacent to one another with the rods of the upper bank horizontally in front of the rods of the lower bank, to a position wherein the rods of the lower rod bank are moved in a direction parallel to and away from the rods of the upper rod bank, to a position wherein the rods of the rods banks are moved such that the rods of the lower rod bank are horizontally in front of the rods of the upper rod bank, to a position wherein the rods of the lower rod bank are moved in a direction parallel to and toward the rods of the upper rod bank until they are generally adjacent to and horizontally in front of the rods of the upper rod bank.

18. The apparatus as claimed in claim 17 wherein said second cycle comprises moving the rods from a position wherein the rods of the respective rod banks are adjacent to one another with the rods of the lower bank horizontally in front of the rods of the upper bank, to a position wherein the rods of the upper rod bank are moved in a direct parallel to and away from the rods of the lower rod bank, to a position wherein the rods of the rods banks are moved such that the rods of the upper rod bank are horizontally in front of the rods of the lower rod bank to a position wherein the rods of the upper rod bank are moved in a direction parallel to and toward the rods of the lower rod bank until they are generally adjacent to and horizontally in front of the rods of the lower rod bank.

19. The apparatus as claimed in claim 15 wherein said feed head includes a toothed roller to press the flexible material against the rods of an adjacent rod bank and into the spaces between the rods of said rod bank.

20. The apparatus as claimed in claim 19 wherein the flexible material is a heat sealable material and said feed head includes a heat applicator to heat flexible material that is in contact with adjacent flexible material to cause the flexible material to be fused together along points of contact.
